(19) United States
(12) Patent Application Publication
(10) Pub. No.: US 2017/0297067 A1
(43) Pub. Date: Oct. 19, 2017

(54) Waste Stream Recovery Conversion Technologies

(71) Applicant: Keith A. Langenbeck, Pleasant View, TN (US)

(72) Inventor: Keith A. Langenbeck, Pleasant View, TN (US)

(21) Appl. No.: 15/488,446

(22) Filed: Apr. 15, 2017

Related U.S. Application Data
(60) Provisional application No. 62/323,778, filed on Apr. 17, 2016.

(51) Int. Cl. B09B 3/00; C02F 11/12; C02F 11/00; B03B 9/00; B03B 9/06

(52) U.S. Cl. CPC B09B 3/00; C02F 11/12; B03B 9/06; B03B 9/00; C02F 11/00

(57) ABSTRACT

A disclosed system and method are configured to process waste via a frontend processing module configured to crush, grind, aggregate and concentrate waste from a coarse material to a finer material including an iterative reprocessing of any oversized components. The disclosed system also includes a classifying module to separate the coarse material from the finer material via a process water and at least one microgrinder and fractioning centrifuge. The disclosed system further comprises a backend processing module configured for further classifying the respective coarse and fine material for energy production and dewatering, recovering and combusting component materials. System submodules are configured to microgrind and gasify or pyrolize a resulting particle slurry into a combustible synthetic gas release for electricity generation and heat. The system is applied to waste recovery of waste glass, electronics waste, coal piles, coal water fuels, biofuels, algae lipid oils, and various precious minerals.

### CROSS-REFERENCE TO RELATED APPLICATION

This application claims the benefit of the priority date of earlier filed U.S. Provisional Patent Application Ser. No. 62/323,778, titled ‘Waste Stream Recovery Technology’ filed Apr. 17, 2016 by Keith A. Langenbeck, and is incorporated herein by reference in its entirety.

### BACKGROUND OF THE INVENTION

Municipal landfills, repositories for electronic product waste (eWaste) and obsolete computer components, coal waste piles (aka gob piles), coal ash repositories, precious metal mining tailing piles and the like represent vast stores of valuable minerals and energy forms, if those commodities can be harvested cleanly, efficiently and affordably. However, technology lags for the recovery of valuable commodities, unique systems for economic recovery of certain valuable commodities and unique applications for recovering and harvesting valuable energy forms. Improvements in applied technology and recovery systems for waste stream processing are also needed for general application in commercial mining, commodity energy production and fuel production operations.

One consequence of reducing the number of coal fired power plants used to produce electricity is a concomitant reduction of coal flyash. Some types of coal ash, types C and F, have historically been used as beneficial additives in concrete recipes. Some of the challenges in the recovery and conversion of landfill glass are: (1) separation of the non-glass [plastic, aluminum, steel, cork, labels and such] from the glass, (2) removing the majority of the materials adhered to the glass surfaces such as adhesives, food stuffs, soft drinks, beer, wine and etcetera, (3) washing and cleaning of the glass particles sufficiently so that carried over contaminants do not degrade the cement chemistry and concrete strength, (4) treatment systems to extract contaminants from the wash water so it can be recycled and (5) classifying the ground glass particles to ensure the particle size specifications and size distribution are met in the finished product.

Therefore a market need for waste stream recovery conversion technologies has existed but has gone unmet by the presently available developments and methods.

### SUMMARY OF THE INVENTION

A disclosed system and method are configured to process waste includes a frontend processing module configured to one of crush, grind, aggregate and concentrate waste from a coarse material to a finer material including an iterative reprocessing of any oversized components. The disclosed system also includes a classifying module configured to separate the coarse material from the finer material via a process water or fluid and at least one microgrinder and at least one fractioning centrifuge. The disclosed system further comprises a backend processing module configured to at least one of further classifying the respective coarse and fine material for energy production and dewatering, recovering and combusting component materials.

System submodules are configured to microgrind and gasify or pyrolyse a particle flow for a combustible synthetic gas release for electricity generation and heat. The disclosed system and method are applied to waste recovery of waste glass, electronics waste, coal piles, coal water fuels, biofuels, algae lipid oils, precious minerals and various different minerals into heat and electrical energy for internal use and sales.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 illustrates a system diagram for the unique remediation and material recovery of waste glass in accordance with an embodiment of the present disclosure.

FIG. 2 illustrates a system diagram for the unique remediation and material recovery of valuable materials from electronics waste, computer board waste, green board, e-board (electronic board) or eWaste (electronic waste) in accordance with an embodiment of the present disclosure.

FIG. 3 illustrates a system diagram used in the unique remediation and recovery of valuable material from waste coal piles (aka gob piles, gob coal, culm or boney) common to coal mining regions in accordance with an embodiment of the disclosure.

FIG. 4 illustrates a system diagram used in the unique remediation and recovery of valuable minerals and material from coal ash repositories that arise from coal power plant operation in accordance with an embodiment of the present disclosure.

FIG. 5 illustrates a system diagram used in production of coal water fuels (CWF, also known as coal water slurry fuels, CWSF) in accordance with an embodiment of the present disclosure.

FIG. 6 illustrates a system diagram used in production of a unique hybrid solid or rigid biofuel in accordance with an embodiment of the present disclosure.

FIG. 7 illustrates a system diagram used in lysing, separating and recovering of algae lipid oils from algae bodies in accordance with an embodiment of the present disclosure.

FIG. 8 illustrates a system diagram used in grinding, microgrinding to uniform particle sizes, fractioning centrifuge separation of uniform particle sizes by differential particle density and recovery of valuable precious and non-precious minerals in accordance with an embodiment of the present disclosure.

FIG. 9 illustrates a system diagram used in grinding, microgrinding to uniform particle sizes, fractioning centrifuge separation of uniform particle sizes by differential particle density and recovery of various different minerals in accordance with an embodiment of the present disclosure.

Throughout the description, similar or same reference numbers may be used to identify similar or same elements in the several embodiments and drawings. Although specific embodiments of the invention have been illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure and continuances and/or divisional disclosures thereof, the term ‘classify’ refers to a mechanical separation of pieces or particle components into larger coarse material and into smaller finer material. The term ‘dewatering’ refers to the process of removing water or a fluid from a slurry and therefore also applies to reducing the concentration of the fluid. The use of the term ‘water’ therefore also applies to ‘fluids’ as well in the specification and the drawings. The term ‘microgrinding’ refers to a fluid mechanical grinding of particles and pieces to produce material measuring nominally in microns. The term ‘nominal’ refers to an average or a median or a benchmark number or measurement that may differ by ten percent or by a multiple sigma variation or by design according to manufacturing and economic considerations. Other terms herein may take their common denotation meaning found in trade journals, thesis, other scholarly papers and other industry accepted technical references.

This application discloses technology uniquely applied in the recovery of valuable commodities, unique systems for economic recovery of certain valuable commodities and unique applications of the herein described technology for recovering and harvesting valuable energy forms. The technology and recovery systems described for waste stream processing also have general application in commercial mining, commodity energy production and fuel production operations.

A potential replacement for beneficial flyash types is ground glass/silica with a particle size of approximately 45 micron and less. Landfill glass harvested, cleaned and processed to the proper particle size could be an affordable replacement in concrete recipes.

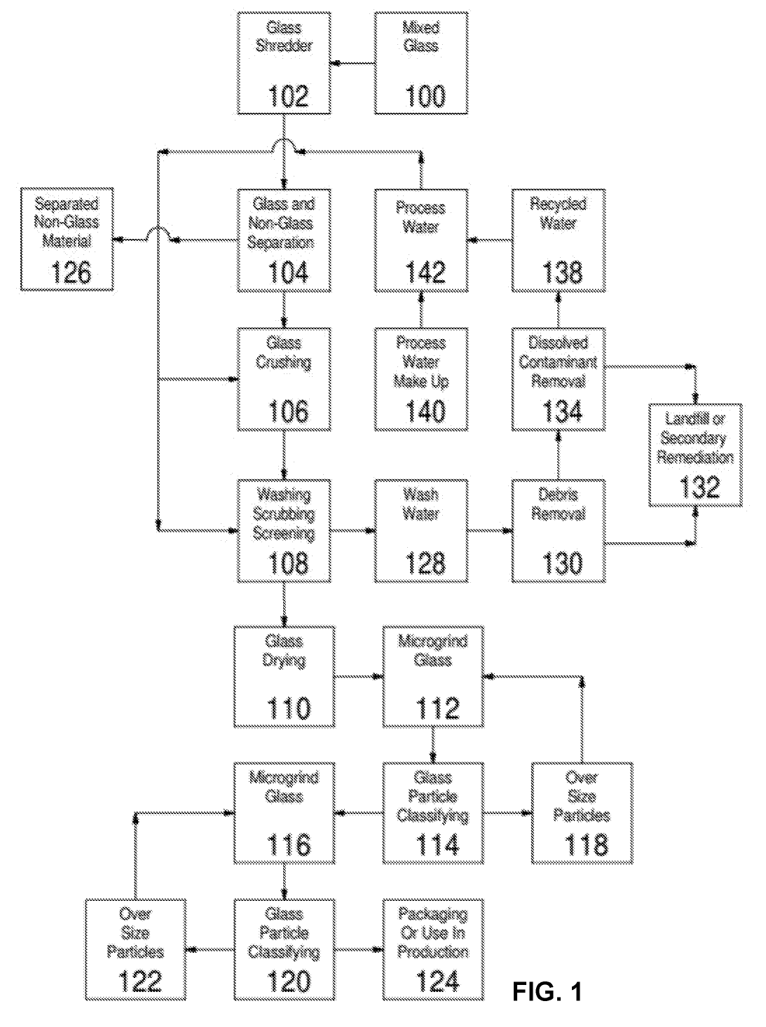

FIG. 1 illustrates a system diagram for the unique remediation and material recovery of waste glass in accordance with an embodiment of the present disclosure. It includes but is not limited to taking mixed glass 100 into a glass shredder 102, crushing, washing, grinding, drying, classifying, microgrinding including rod mill grinding down to the desired particle size and recovery of glass for reuse as further described below.

This system anticipates the conversion of feedstock material harvested from a landfill, glass presort operations at municipal waste transfer facilities, curbside recycling, reject glass from glass manufacturing and other operations. Presorted glass, before being deposited in the landfill, poses essentially the same technical challenge as landfill glass except that the level of contamination and dirt adhered to the glass waste stream should be less. The washing process and water recycling effort would be less challenging with presorted glass but still required. Soluble organic and mineral contaminants, if not removed in the washing and drying steps could corrupt cement chemistry and cause concrete recipes to fail.

The system of FIG. 1 is configured to receive feedstock of raw mixed glass 100 that is shredded 102 to a reduced size. Non-glass 126 is separated 104 from the glass prior to additional crushing 106 of the separated glass to further reduce glass particle size. Washing, scrubbing and particle size screening 108 follows the crushing operation 106. Spent wash water 128 undergoes debris removal 130 and remediation or decontamination via dissolved contaminant removal 134 to enable water recycling 138 and water reuse in the system. Process water is made up 140 to feed the process water 142 for glass crushing 106 and washing, scrubbing and screening 108. Glass coming from the washing, scrubbing and screening 108 is dried 110 prior to any particle size reduction through microgrinding 112. The first microgrinding step 112 is by particle size classification 114 with over-sized particles returned back 118 to the microgrinding process 112. The second microgrinding process 116 receives the glass particles from the first glass particle classifying process 114 that were not oversized and reduces the glass particle size further. A second classifying process 120 follows the second microgrinding process 116 with oversized particles being returned back 122 to the second microgrinding 116 process. Glass particles from the second classifying process 120 of the specified particle size 124 are used or packaged for future use. The FIG. 1 diagram shows a 2 step microgrinding and classifying sequence but 3 or more microgrinding and classifying steps are anticipated and included in this disclosure as well.

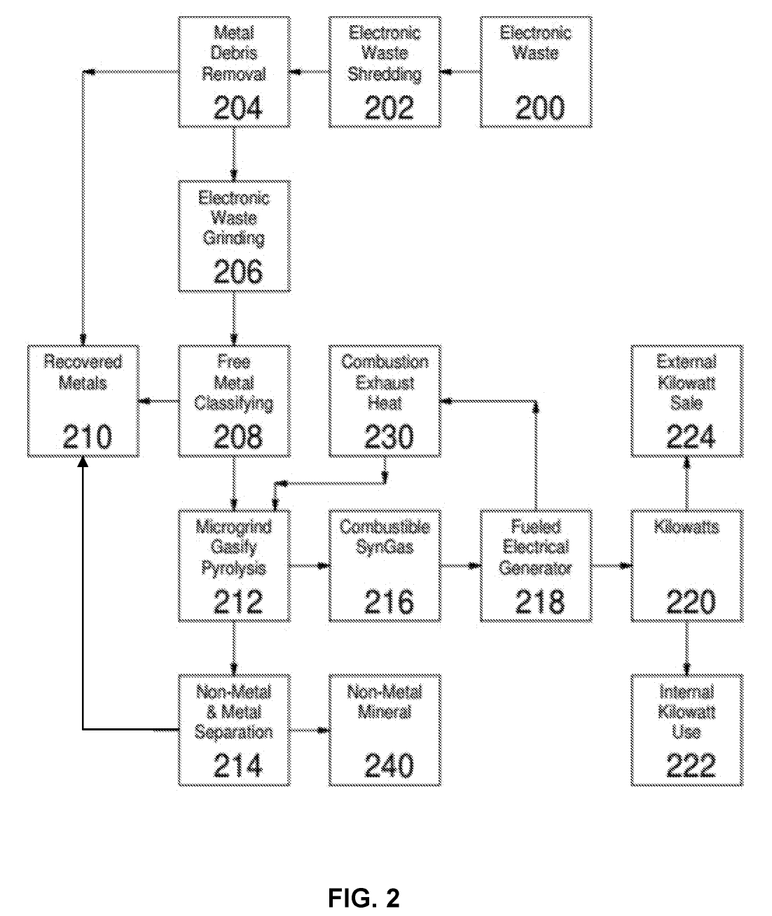

FIG. 2 illustrates a system diagram for the unique remediation and material recovery of valuable materials from electronics waste, computer board waste, green board, e-board or eWaste in accordance with an embodiment of the present disclosure. It includes but is not limited to shredding, crushing, separating, grinding, simultaneous grinding, gasifying or pyrolysis of electronic waste, recovery of valuable metals for reuse and conversion of phenolic or plastic material into an energy source like hydrogen or syngas.

The system of simultaneous grinding, gasifying and pyrolysis of electronic waste uniquely solves the problem of separating valuable metals and minerals intimately encased by phenolic resin or other plastics. The surrounded metals are commonly copper, aluminum, rare earth elements, steel, precious metals and the like. The aggregated metals can represent as much as 70% of the weight. Combining the gasification and pyrolysis processes while the e-board particles are simultaneously being ground minimizes and removes the surface formation of tars and char that restrict the rapid conversion of the phenolic material into useful combustion gases like hydrogen. The unique combination of grinding action with pyrolysis and gasification in a single unit process minimizes or eliminates the need for certain catalysts that can prevent the formation of tars and char. Those tars and char can impede conversion of phenolic material to valuable combustion gases. The combined grinding, gasifying and pyrolysis of the eWaste also eliminates liquid solvents used to dissolve away the phenolic or plastic material encasing the valuable metal constituents.

The system of FIG. 2 receives electronic waste 200 that is shredded 202 to a reduced size to liberate free metal pieces for removal 204. The remaining electronic waste is ground 206 before additional free metal recovery and classifying 208. After initial grinding 206 and free metal separation and classifying 208, remaining eWaste particles are introduced to a combination microgrinding and gasification/pyrolysis process 212. The combustible gases 216 that come from conversion of the phenolics in computer boards, plastic cases for monitors or keyboards and the like are used to fuel electrical generators 218. Waste heat from the combustion exhaust 230 from the electrical generators is used in the microgrinding and gasification/pyrolysis 212 while the kilowatts generated 220 are used internally to the system 222 or sold external 224 to the grid. After the phenolic or plastic materials have been sublimated the remaining recovered metals 210 and other non-metal minerals 240 like silica are discharged from the combination microgrinding and gasification/pyrolysis process 212 and separated 214.

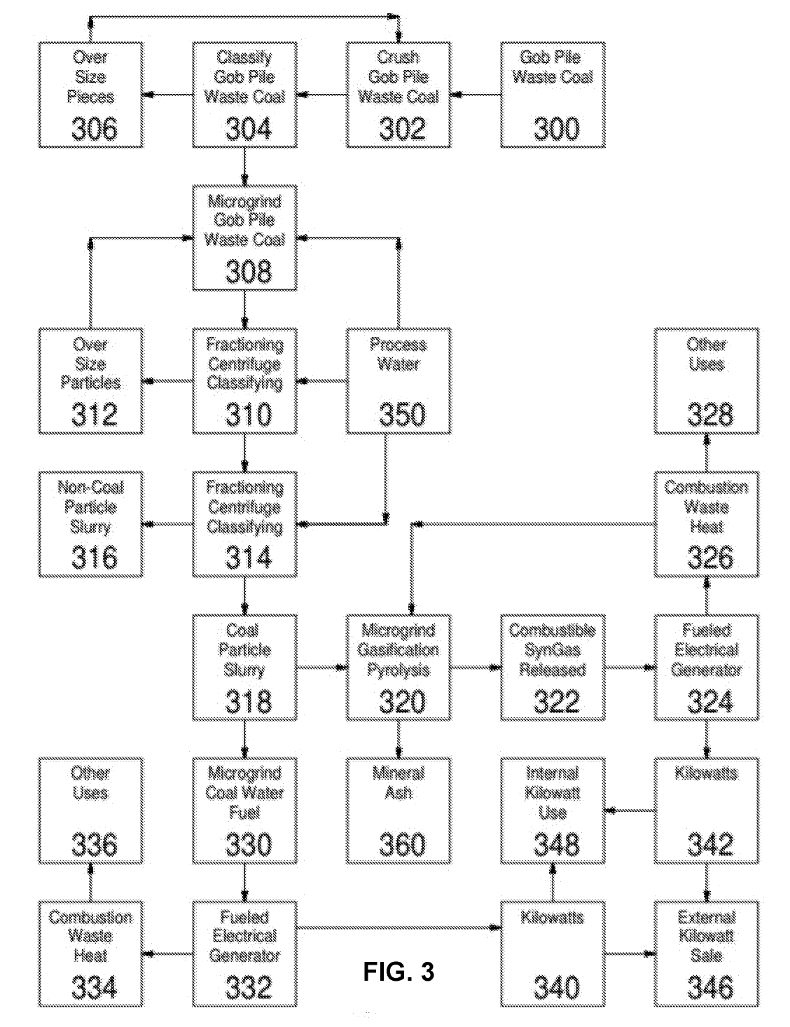

FIG. 3 illustrates a system diagram used in the unique remediation and recovery of valuable material from waste coal piles (aka gob piles, gob coal, culm or boney) common to coal mining regions in accordance with an embodiment of the disclosure. It includes but is not limited to shredding, crushing, washing, grinding, classifying, microgrinding down to the desired common particle size, separating coal particles from non-coal particles by fractioning centrifuge and conversion of the recovered coal into electrical energy.

The system anticipates the separation of the coal from commingled non-coal and consequent environmental restoration of the waste coal dump site. Gob coal piles are the discharge from coal mining operations that have run out of the coal seam and cause the mixing of non-coal with coal. The gob coal has insufficient BTU (British Thermal Units) value for conventional combustion uses and severe air emissions result when burned. Site remediation would end rainwater leaching of contaminants into the ground water and recovery of the coal for use in conventional combustion, production of coal water fuels (CWF), gasification or pyrolysis into synthetic natural gas and conversion into commercial chemicals. Instrumental in this unique separation of the non-coal from the coal is grinding the gob coal down to uniform particle sizes, which enables fractioning centrifuge separation of non-coal and coal particles by varying specific gravity. The now separated coal can be used in power generation, coal water fuel production and conversion to synthetic natural gas.

The system of FIG. 3 receives waste coal or gob coal 300 that is crushed 302 to a reduced size for size classifying 304. Oversize pieces and particles 306 may be returned back to the initial crushing operation 302 for further processing. Microgrinding 308 of the coal gob with process water 350 results in a slurry of small, similar sized coal particles 318 and a non-coal particle slurry 316. The particles in the slurry are separated 310 by their differential weights based upon mineral density. Over size particles 312 from the fractioning centrifuge classifying 310 are recycled into the microground gob pile of waste coal 318.

Once isolated, the coal water slurry 318 is received by the microgrinding gasification/pyrolysis 320 or further microgrind processing into coal water fuels 330. Combustible syngas 322 released is used to produced electrical power 342 for internal 348 use or external 346 sale. Waste heat 326 from the electrical generation 324 is used in the microgrinding gasification/pyrolysis 320. Mineral Ash 360 may result from the microgrind and gasification/pyrolysis 320. Coal slurry 318 could also be fed to coal water fuel microgrinding process 330. The process output is used to fuel diesel type generator engine or turbines 332 in the generation of electrical power 346 and 348. Waste heat 334 from the coal water fueled electrical generation 340 could be used for other purposes 336 and 328.

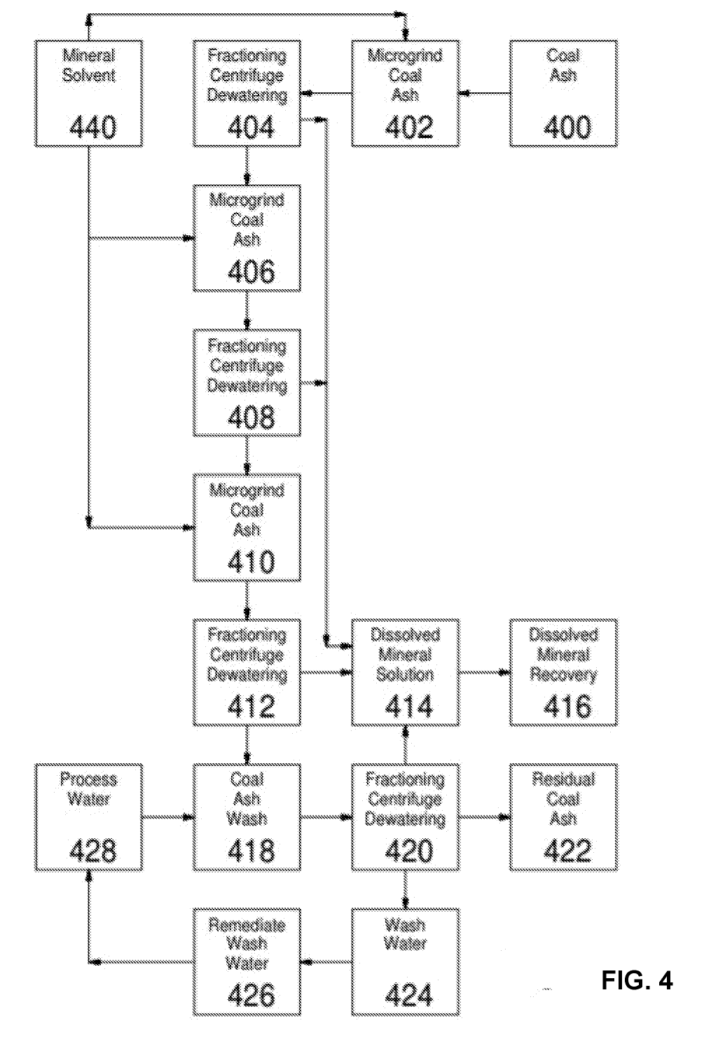

FIG. 4 illustrates a system diagram used in the unique remediation and recovery of valuable minerals and material from coal ash repositories that arise from coal power plant operation in accordance with an embodiment of the present disclosure. It includes but is not limited to grinding, washing, dissolving, classifying, microgrinding to expose and facilitate the recovery of valuable minerals encased in the glass like coal ash particles, dewatering and particle separation by fractioning centrifuge, dissolved mineral recovery, reuse of processed coal ash for geological remediation and beneficial concrete additives, remediation and elimination of coal ash repositories as the environmental hazard sites.

The system anticipates the extraction of high value minerals found within coal flyash, the combustion byproduct when coal is burned in electrical power plants. High concentrations of rare earth elements can be found in Appalachian coal ash. Microgrinding of the coal ash particles, which are encapsulated within a glassy matrix of aluminum silicates, in a solution of certain acids to extract minerals is a unique and efficient approach to recover sought after minerals. During microgrinding, abrasion of the coal ash particle exterior and increased surface area enables mineral recovery in the solvent slurry.

The system of FIG. 4 receives coal ash 400 or other residual coal combustion byproducts such as bottom ash or clinker may require crushing or other preprocessing before being introduced to the disclosed process circuit. Coal ash 400 particles, collected in the flue stacks of coal powered generating plants, are typically very small in the range of 45 microns. During the initial microgrinding step 402, liquid mineral solvents 440 like nitric acid or others are added to a resulting liquid slurry during the grinding operation. In the microgrinding process the ash particles are reduced in size, the surface area is increased and the solvent is exposed to the sought after minerals simultaneously. After the first microgrinding process 402 has run its course, the slurry is dewatered by fractioning centrifuge 404 to separate the mineral bearing solution 414 from the residual coal ash into dissolved mineral recovery 416. Sequential microgrinding 406 and 410 and dewatering steps 408, 412, and 420 repeat the process of particles being reduced in size, the surface area being increased and the solvent being exposed to the sought after minerals simultaneously to maximize the extraction of minerals encased within the coal ash particles. The fractioning centrifuge U.S. Pat. No. 8,397,918B2 is uniquely suited to separate the ash particles from the solution due to its high G-force and laminar flow fluid handling operation. Coal ash particles at or below 45 microns tend to naturally float or suspend in fluids and not settle out. Reducing the coal ash particle size during the slurry microgrinding further increases the difficulty of separating the valuable solution from the residual ash particles. After the last microgrinding 410 and dewatering 412 steps, the residual coal ash particles are washed 420 or slurried with process water 428 to clean the residual coal ash particles 422 as it can have commercial value as beneficial additives to concrete and others uses. The wash water 424 feeds the remedial wash water 426 and the process water 428 which feeds the coal ash wash 418 in a loop including the fractioning centrifuge dewatering 420.

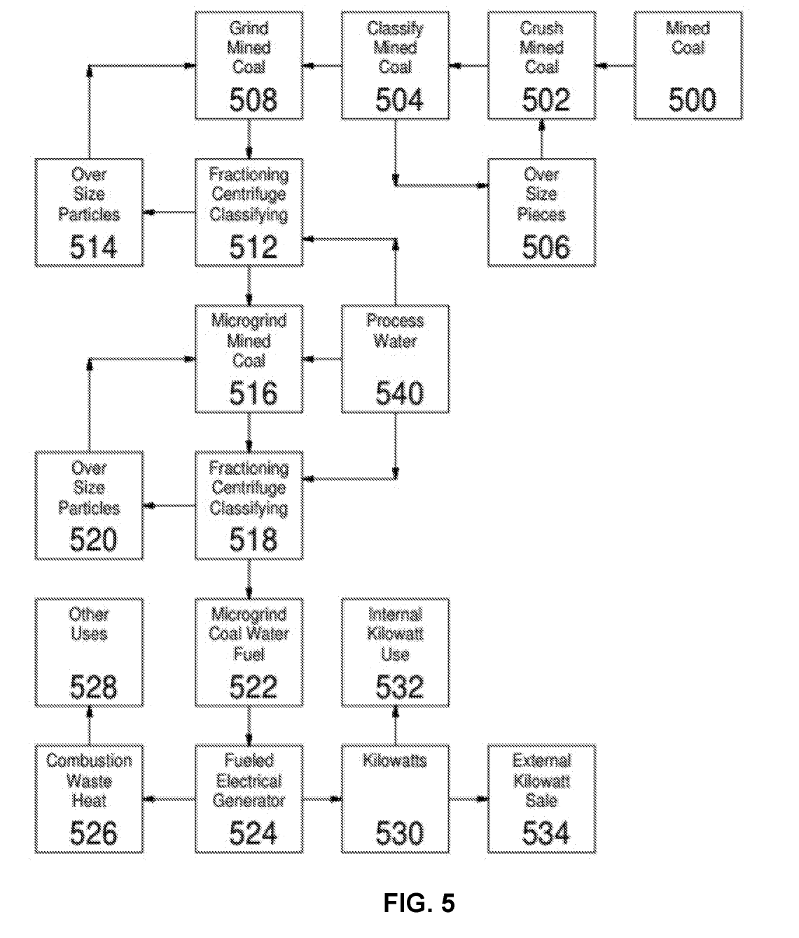

FIG. 5 illustrates a system diagram used in production of coal water fuels (CWF, also known as coal water slurry fuels, CWSF) in accordance with an embodiment of the present disclosure. It includes but is not limited to crushing, washing, grinding, classifying, microgrinding down to the desired common particle size, separating larger coal particles from smaller coal particles by fractioning centrifuge and conversion of the coal into electrical energy.

The system anticipates the production of viable coal water fuels on small or large scale with particle size distribution of 100% less than or equal to 20 micron or smaller. This unique coal water fuel differs from previous coal water fuels, which have had statistically normal particle size distributions with a desired mean particle size. Coal water fuel prepared with a particle size distribution of 100% less than or equal to 20 micron could eliminate the need for hardened internal engine parts (such as intake and exhaust valves, valve guides, piston rings, turbochargers and etcetera), promote stable particle suspension in water without use of stabilizing additives, reduced exhaust emissions, result in more complete combustion and other benefits.

The system of FIG. 5 receives mined coal 500 that is crushed 502 and classified 504 and then ground 508 in a series of steps to reduce the particle size. Over size pieces 506 from the classifying 504 are recycled into the crush mined coal 502. The ground mined coal 508 is sent to microgrinding 516 and fractioning centrifuge classifying 518. The particles are separated by their differential weights based upon different particle size. Over size particles 520 from the fractioning centrifuge classifying 518 are recycled into the microgrind 516. Process water 540 aids the steps 512, 516 and 518. After grinding 508 and classification 512 via a fractioning centrifuge, the coal and water are microground 522 to a fuel until the coal particle size distribution is 100% less than or equal to 20 microns and used for electric generation 524. Over size particles 514 from the fractioning centrifuge classifying 512 are recycled into the grind mined coal 508. Coal particle sizes at 100% less than or equal to 20 micron naturally stay in suspension without additives, are small enough to prevent internal damage, wear to engine parts, are proven to be a clean coal fuel with reduced emissions and are difficult to produce by previous methodologies. A suspension of coal in water in the range of 50:50 can be used to fuel diesel (compression ignition) type reciprocating engines or turbines 524 that generate electrical power 530 for internal use 532 or external sale 534. Combustion waste heat 526 from the fueled electric generator 524 may be used for other uses 528 including heating and energy recycling.

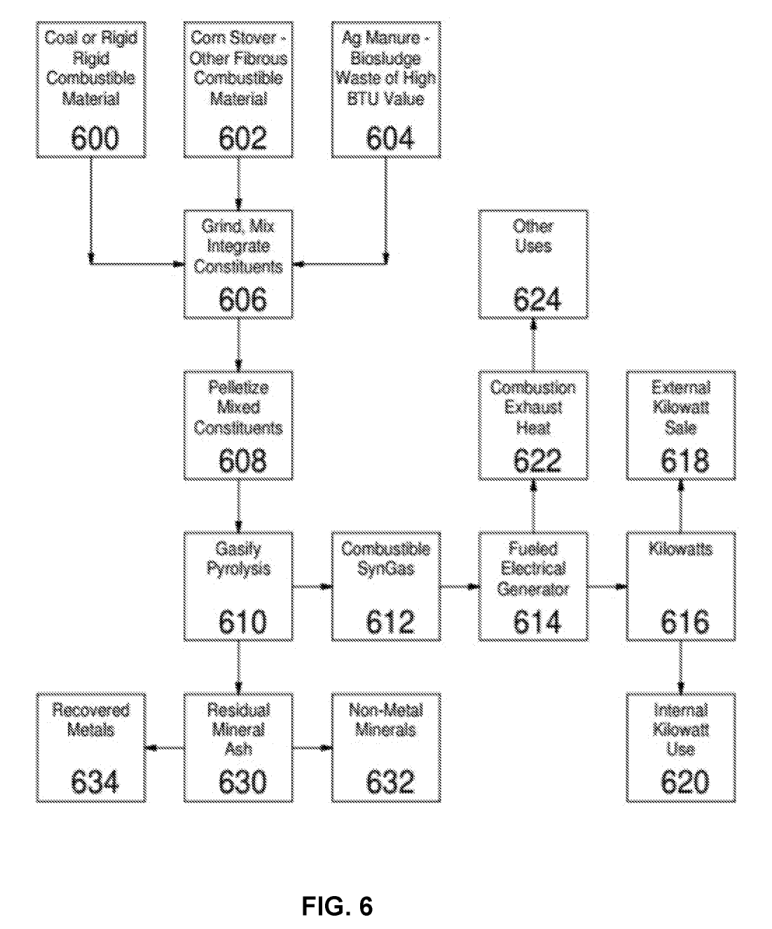

FIG. 6 illustrates a system diagram used in production of a unique hybrid solid or rigid biofuel in accordance with an embodiment of the present disclosure. It includes but is not limited to crushing, grinding, integration of various constituents to result in a hybrid solid or rigid fuel, pellet or briquette production from the various constituents, gasification and pyrolysis of the pellet or briquette solid or rigid fuel into syngas, combustion of syngas for generation of electrical power, conversion of syngas into liquid fuels or petrochemical feedstock and use waste heat from electrical generation for other functions.

The disclosed system anticipates production of a unique hybrid solid or rigid fuel that overcomes current material handling and processing hurdles in the conversion of various biomass categories. It would combine a solid aggregate core particle (such as coal, shredded plastic, shredded wood) part in combination with relatively dry, lightweight, low density fibrous matrix (such as corn stover, sugar cane bagasse, straw, hemp wastes) part and a relatively liquid (such as municipal waste water solids, anaerobic digester discharge, animal manure/sludge) part into a pellet or briquette solid fuel. Among the many benefits, the solid or rigid hybrid fuel would have uniform and higher heat value, be easily handled by conventional material handling means, convert lightweight biomass at or near the point of origin, convert toxic biomass sludge/manure at or near the point of origin, concentrate and capture valuable and toxic minerals currently contaminating the environment, obviate the need for drying biomass before conversion as the fibrous part would absorb moisture content from the liquid part and others.

For example, using coal as the solid core part and pig manure as the liquid part allows for recovery of the rare earth elements, sulfur, arsenic, mercury et al from the coal fraction and copper, zinc, potassium, nitrogen, phosphorous et al from the pig manure fraction. The mineral fraction from the coal and the mineral fraction from the pig manure would be commingled in the residual ash byproduct from gasification or pyrolysis. The fibrous and liquid parts in the hybrid fuel would be sourced locally from hog and corn farmers. The coal would be easily shipped in by rail or truck. Waste heat from generator engines or turbines could be used for heating animal raising operations or hot house vegetable farming in the cold months. Anaerobic digesters, familiar to concentrated animal farming/feeding operations (CAFO), only convert half of the raw manure feedstock to methane with the cellulosic remainder typically being land applied. Consequently, this methane digester sludge could be used as the liquid part in the hybrid fuel and eliminate heavy metal contamination of the soil.

The system of FIG. 6 receives feedstocks of solid or rigid combustible constituent 600 like ground coal or the like, fibrous combustible material 602 such as left over corn stalks, stover, sugar cane bagasse or low quality hemp fiber or the like and a liquid, viscous component 604 that has high btu value as well including manure, biosludge and municipal waste of high BTU value. The feedstocks would be mixed and integrated 606 to allow grinding, integration and pelletization 608 and pressing into pellets and briquettes. Pelletization and briquette formation allows for ready transportation of the hybrid fuel and conventional material handling in solid fuel operations like gasification/pyrolysis processes 610. It is anticipated that the pelletized hybrid fuel would be produced and used at commercial farming operations such as hog farming to eliminate animal manure wastes. Fuel 612 including combustible syngas fuels an electric generator 614 to generate kW 616 of electricity for internal farm use 620 and external sale 618 to local and remote grids. Waste heat 622 from the kilowatt generation could be used to heat animal buildings, hot house vegetable operations and other uses 624. The leftover residual ash 630 from the gasification/pyrolysis processes 610 would contain valuable non-metal minerals 632 and recovered metals 634 that are conventionally unrecovered.

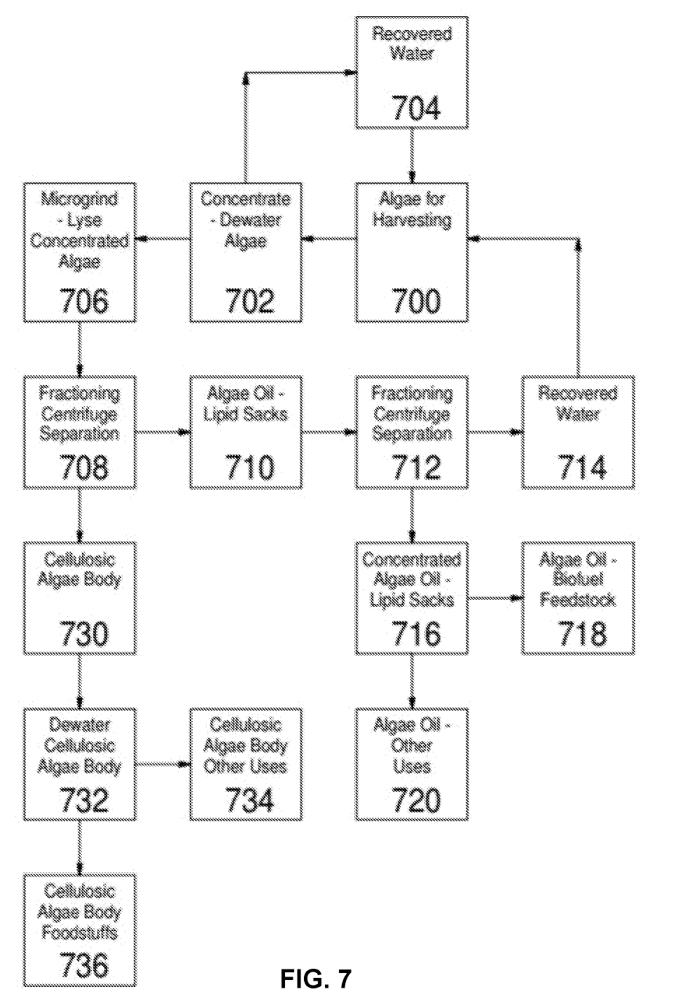

FIG. 7 illustrates a system diagram used in lysing, separating and recovering of algae lipid oils from algae bodies in accordance with an embodiment of the present disclosure. It includes but is not limited to microgrinding, lysing, classifying by fractioning centrifuge, microgrinding algal biomass fluids to open or lyse the exterior cell wall of the algal bodies, mechanical separating the interior lipid oil sacks from the rest of the algal bodies by fractioning centrifuge, concentrating and dewatering of the lipid oil fraction and concentrating and dewatering of the remaining algal bodies after lipid oil sack separation.

The primary hurdle or constraint in the commercial production of algae oil as a biofuel feedstock has been opening the cellulosic exterior of the algae body and removing the lipid oil sack from its interior. The disclosed system anticipates the lysing, opening or cracking of the algae body by unique vibration, mild abrasion and frequencies introduced by rod mill microgrinding to the algal biomass, mechanical separation and concentration of the algae oil lipid sacks by fractioning centrifuge and concentration of algal oil by mechanical means without the use of solvents. Mechanical methods of opening algae bodies and removing the lipid oils therein, also eliminates the high cost of solvents like butanol or others. These solvents can be toxic and render the residual algae bodies unfit for animal or human consumption. Mechanical lysing and concentration of the lipids and algae bodies allows for utilizing the entire algal biomass, prevents toxic contamination of algae growing operation, allows reuse of the grow water recovered in the dewatering step and maximizes the value of the entire biomass operation.

The system of FIG. 7 receives algal feedstock for harvesting 700 from commercial algae growing operations. One of the challenges of algae growing is concentrating the amount of algae from the growing operation. The concentration and dewatering step 702 is accomplished by a fractioning centrifuge or other means to produce concentrated algae before being processed by microgrinding 706 to produce the concentrated algae. Water recovered 704 from the dewatering step 702 is recycled into the feedstock for harvesting 700. The agitation, frequencies and vibrations introduced by microgrinding 706 uniquely results in the opening or disintegration of the exterior algae shell, also known as lyzing. After the lyzing operation 706 the fluids would be subjected to the fractioning centrifuge to separate 708 the interior lipid sacks 710 which contain high grade vegetable oil. Further concentration of the lipid sacks via a subsequent fractioning centrifuge separation 712 removes and recovers excess water 714 thereby concentrating the algae oil lipid sacks 716 and improving the value of thealgae oil biofuel feedstock 718 or preparing the algae oil for other uses 720. Fractioning centrifuge separation 708 of the lipid sacks after lyzing also separates the cellulosic exterior body or shell 730. After dewatering, the cellulosic algae bodies 732 can be used in new generation ethanol production 734, animal feedstock and human food supplements 736.

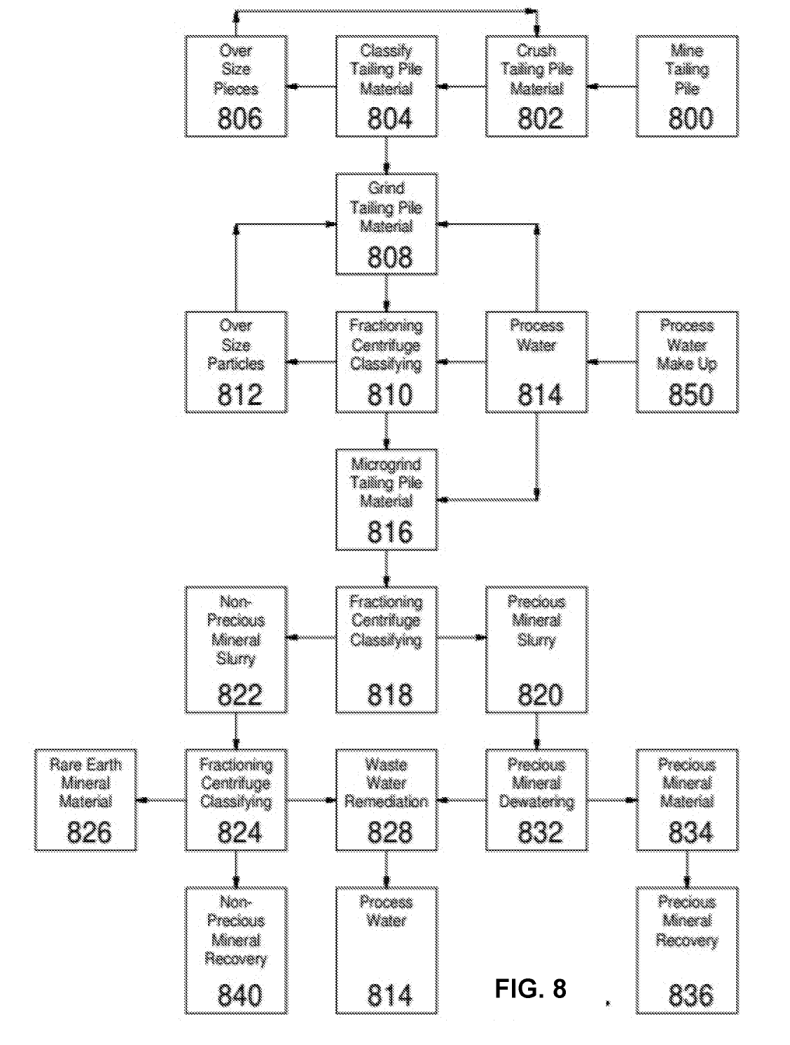

FIG. 8 illustrates a system diagram used in grinding, microgrinding to uniform particle sizes, fractioning centrifuge separation of uniform particle sizes by differential particle density and recovery of valuable precious and non-precious minerals in accordance with an embodiment of the present disclosure. It includes but is not limited to crushing, classifying, grinding, classifying by fractioning centrifuge, grinding to nominally uniform particle size of tailing pile feedstock, separating certain mineral particles from certain other mineral particles by fractioning centrifuge based upon gradients in particle density or weight and dewatering separated mineral stream fractioning centrifuge.

The disclosed system anticipates the use of rod mill microgrinding in conjunction with fractioning centrifuge separation of certain minerals commingled in mining tailing piles throughout the American West and other locations. This system anticipates using environmentally friendly methods different than non-environmentally friendly methods found in conventional mining operations. Microgrinding the tailing pile raw material to small, uniform particle size allows for fractioning centrifuge concentrating and separating of the different materials from a water slurry by different particle weight. Afterwards, the sought after mineral fraction can be dewatered, further refined and smelted by conventional means. This methodology applies as well for regular mineral mining operations.

The system of FIG. 8 receives feedstock of mine tailing pile material 800 that would be crushed 802 and classified 804. Afterwards it is ground 808 and classified via fractioning centrifuge 810 to further reduce the particle size. Over size pieces 806 and over size particles 812 are recycled to the crushing step 802 and the grinding step 808 respectively. A microgrinding process 816 acting on the reduced particle size from 810 with water 814 made up from process water 850 generates a slurry with nominally uniform particle sizes of the various minerals. The particles in the slurry will be separated or classified via a fractioning centrifuge 818 by their differential weights based upon varying mineral density. The precious mineral fraction 820 would typically have heavier particle weights than non-precious mineral fraction 822. Once separated and concentrated, conventional recovery methods of the precious metals 836, non-precious metals 826 and minerals 840 are employed. A third fractioning centrifuge 824 classifies by separating even finer particles in the 822 slurry for waste water remediation 828 and process water output 814. The precious mineral slurry 820 is dewatered 832 and the resulting mineral material 834 can therefore be recovered.

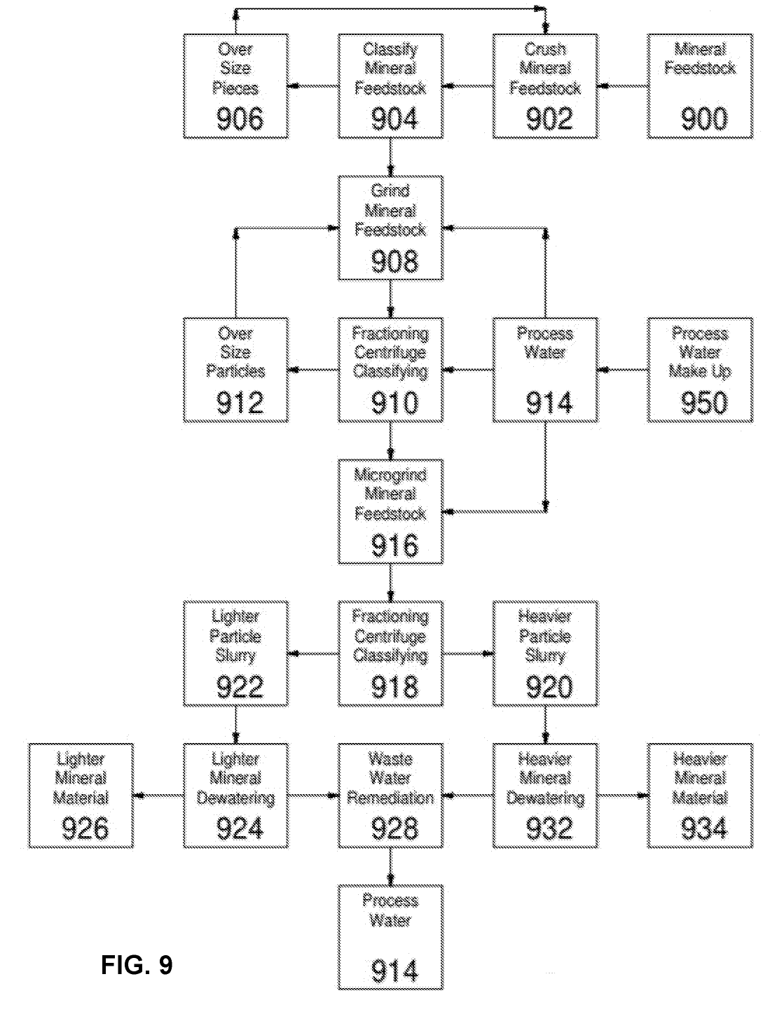

FIG. 9 illustrates a system diagram used in grinding, microgrinding to uniform particle sizes, fractioning centrifuge separation of uniform particle sizes by differential particle density and recovery of various different minerals in accordance with an embodiment of the present disclosure. It includes but is not limited to crushing, classifying, grinding, classifying by fractioning centrifuge, grinding to nominally uniform particle size of raw material feedstock, separating certain mineral particles from certain other mineral particles by fractioning centrifuge based upon gradients in particle density or weight and dewatering separated mineral streams via a fractioning centrifuge.

The system anticipates the use of rod mill microgrinding in conjunction with fractioning centrifuge separation of certain minerals commingled in raw ore or other aggregations. This system anticipates using environmentally friendly methods different than non-environmentally friendly methods found in conventional mining operations. Microgrinding the raw material to small, uniform particle size allows for fractioning centrifuge concentrating and separating of the different minerals or materials from a water slurry by the different particle weight. Afterwards the different mineral or material fractions can be dewatered, further refined and recovered by conventional means. This methodology applies for regular mineral mining operations.

The system of FIG. 9 receives mineral feedstock 900 to be crushed 902 and classified by separation 904. Afterward it is ground 908 and classified further via a first fractioning centrifuge 910 to further reduce the particle size. Over size particles 912 are recycled to more grinding 908 and over size pieces 906 are recycled to more crushing 902. A microgrinding 916 process with water 914 made up in 950 generates a slurry with nominally uniform particle sizes of the various minerals. The process water also aids the grinding 908 and the classifying separation 910. The particles in the slurry will be separated via a second fractioning centrifuge 918 by their differential weights based upon varying mineral density. For example, one mineral fraction 920 would have heavier particle weights than the lighter mineral fraction 922. Once separated and concentrated, recovery methods for the heavier minerals 934 and lighter minerals 926 are employed including a heavier mineral dewatering 932 and a respective lighter mineral dewatering 924 into waste water remediation 928 and process water 914.

A common goal of the disclosed processes is to grind the mixed coal and non-coal to uniform particle sizes in a slurry of water. A fractioning centrifuge separates the coal from the non-coal. The coal, being lighter, will move out through the rotating hollow shaft pathway and the non-coal out the bottom pathway. Further grinding of the coal slurry stream results in a useful, clean burning fuel known as coal-water-fuel, useful as a cleaner burning replacement for diesel.

Further distinguishing from conventional methods, the present disclosure gasifies or pyrolysizes the coal simultaneous with grinding the particle size ever smaller. This refreshes/cleans/agitates the surface of the eWaste particles and enables accelerated conversion versus regular gasification.

Synthetic Natural Gas burns more cleanly than coal and essentially no different than regular natural gas. The cost per BTU for coal is less than the cost per BTU of natural gas from Oil and Gas petroleum operations, and it does not have the produced water disposal issues.

This simultaneous flash grinding-gasification pyrolysis concept can be applied to various biomass feed stocks and others including the flash grinding-gasification pyrolysis of eWaste/greenboard/printed circuit phenolic board material to hydrogen and the vast metals within the phenolic board fully recovered. The disclosed flash processes apply grinding, gasification and pyrolysis over a predetermined short period of time at a predetermined high temperature.

The present disclosure therefore fills the long felt need for a better and more efficient and economical recovery of waste materials into useable materials, electrical energy and heat.

The unique features and novel inventions within this disclosure have various applications and are not limited in scope to the uses described herein. Although the components herein are shown and described in a particular order, the order thereof may be altered so that certain advantages or characteristics may be optimized. In another embodiment, instructions or sub-operations of distinct steps may be implemented in an intermittent and/or alternating manner.

Notwithstanding specific embodiments of the invention have been described and illustrated, the invention is not to be limited to the specific forms or arrangements of parts so described and illustrated. The scope of the invention is to be defined by the claims and their equivalents.

What is claimed is:

1. A system configured to process waste, the system comprising:
a frontend processing module configured to one of crush, grind, aggregate and concentrate waste from a coarse material to a finer material including an iterative reprocessing of any oversized components;
a classifying module configured to separate the coarse material from the finer material via a process water and at least one microgrinder and at least one fractioning centrifuge; and
a backend processing module configured to at least one of further classifying the respective coarse and fine material for energy production and dewatering, recovering and combusting component materials.

2. The system configured to process waste of claim 1, wherein the frontend processing module comprises a plurality of submodules configured to crush a gob pile of waste coal and classify the crushed gob pile for a microgrinder including an iterative reprocessing of oversized particles.

3. The system configured to process waste of claim 1, wherein the classifying module comprises a microgrinder, a first fractioning centrifuge and a process water supply thereto configured in an iterative loop to reprocess oversized particles into a finer slurry.

4. The system configured to process waste of claim 1, wherein the classifying module comprises a microgrinder, a second fractioning centrifuge and a process water supply thereto configured to create a non-coal particle slurry and a coal particle slurry.

5. The system configured to process waste of claim 1, wherein the backend processing module comprises submodules configured to microgrind and gasify and pyrolize the coal particle slurry into a combustible synthetic gas release.

6. The system configured to process waste of claim 1, wherein the backend processing module comprises submodules configured to combust a gasification and pyrolysis of a coal particle slurry for electricity generation and heat.

7. The system configured to process waste of claim 1, wherein the backend processing module comprises submodules configured to combust a microgrind coal particle slurry for electricity generation and heat.

8. The system configured to process waste of claim 1, wherein the backend processing module comprises submodules configured to recover a mineral ash from a gasification and pyrolysis of a coal particle slurry.

9. The system configured to process waste of claim 1, wherein the backend processing module comprises submodules configured to generate kilowatts for use internal to the system and for sale external to the system.

10. A method configured for processing waste, the method comprising:
processing via a frontend processing module configured to one of crush, grind, aggregate and concentrate waste from a coarse material to a finer material including an iterative reprocessing of any oversized components;
classifying via a classifying module configured to separate the coarse material from the finer material via a process water and at least one microgrinder and at least one fractioning centrifuge; and
processing via a backend processing module configured to at least one of further classifying the respective coarse and fine material for energy production and dewatering, recovering and combusting component materials.

11. The method configured for processing waste of claim 10, wherein the frontend processing module comprises a plurality of submodules configured for crushing a tailing pile material or regular ore and classifying the crushed tailing pile or regular ore for microgrinding including an iterative reprocessing of oversized particles.

12. The method configured for processing waste of claim 10, wherein the classifying comprises a microgrinding, a first fractioning centrifuge classifying and a processing water supply thereto configured in an iterative loop for reprocessing oversized particles into a finer tail pile material.

13. The method configured for processing waste of claim 10, wherein the classifying comprises a microgrinding, a second fractioning centrifuge classifying and a processing water supply thereto configured for creating a non-precious mineral slurry and a precious mineral slurry.

14. The method configured for processing waste of claim 10, wherein the classifying comprises a third fractioning centrifuge classifying and a waste water remediation configured for separating a rare earth mineral material and a non-precious mineral recovery.

15. The method configured for processing waste of claim 10, wherein the backend comprises a precious mineral dewatering to a waste water remediating and a process water therefrom and recovering a precious mineral material.

16. A system configured to process waste, the system comprising:
a processing module configured to one of crush, grind, aggregate and concentrate waste from a coarse material to a finer material including an iterative reprocessing of any oversized components; and
a classifying module configured to separate the coarse waste material from the finer waste material via a process water and at least one microgrinder and at least one fractioning centrifuge separator.

17. The system configured to process waste of claim 16, wherein the classifying module comprises a microgrinder, a first fractioning centrifuge and a process water supply thereto configured in an iterative loop to reprocess oversized particles into a mineral feedstock.

18. The system configured to process waste of claim 16, wherein the classifying module comprises a microgrinder, a second fractioning centrifuge and a process water supply thereto configured to create a lighter particle slurry and a heavier particle slurry.

19. The system configured to process waste of claim 16, wherein the classifying module comprises submodules configured to dewater a lighter mineral and a heavier mineral into respective lighter and heavier mineral materials and a waste water remediating and a process water therefrom.

20. The system configured to process waste of claim 16, wherein the processing module comprises submodules configured to receive a mineral feedstock, crush it and classify it for grinding and recrushing of any oversized components.
